(19) United States
(12) Patent Application Publication
(10) Pub. No.: US 2024/0125432 A1
(43) Pub. Date: Apr. 18, 2024

(54) PRESSURE BUILDUP SYSTEM OF CRYOGENIC FLUID STORAGE TANK

(71) Applicant: HYLIUM INDUSTRIES, INC., Seongnam-si, Gyeonggi-do (KR)

(72) Inventor: Seo Young KIM, Yongin-si, Gyeonggi-do (KR)

(21) Appl. No.: 18/475,514

(22) Filed: Sep. 27, 2023

Related U.S. Application Data
(63) Continuation of application No. PCT/KR2022/004338, filed on Mar. 28, 2022.

(30) Foreign Application Priority Data
Mar. 30, 2021 (KR) 10-2021-0041187

(51) Int. Cl. F17C 7/04

(52) U.S. Cl. CPC F17C 7/04; F17C 2205/0326; F17C 2205/0352; F17C 2221/012; F17C 2223/0161; F17C 2227/0302; F17C 2250/043; F17C 2250/0636; F17C 2270/0168; F17C 2270/0184

(57) ABSTRACT

A pressure buildup system of a cryogenic fluid storage tank is disclosed. A pressure buildup system of a cryogenic fluid storage tank comprises: a storage tank for storing cryogenic fluid; a discharge line communicating with the lower part of the storage tank so that the stored fluid flows therein; a first line branching off from the discharge line, and having one end connected to the upper part of the storage tank so that gravity pressure buildup is performed therein; a second line branching off from the discharge line, and having one end connected to an object to which the fluid is supplied; and a third line having one end branching off from a first point of the second line.

### TECHNICAL FIELD

The present disclosure relates to a pressure buildup system of a cryogenic fluid storage tank, and more specifically, relates to a pressure buildup system for controlling the internal pressure in a storage tank in which fluid is stored for smooth fuel supply to a supply target (e.g., a fuel cell or a hydrogen vehicle) in a system for supplying (charging) a fuel such as a certain cryogenic fluid (e.g., liquefied hydrogen, etc.). In particular, the present disclosure relates to a technical idea that allows a conventional gravity pressure buildup unit and a conventional non-gravity pressure buildup unit to be selectively implemented as needed in a single pressure buildup system with a simple and efficient structure.

### BACKGROUND

As seriousness of energy problems caused by use of fossil fuels has emerged, research on alternative fuels has been actively conducted.

Among them, a technical idea of using hydrogen as a fuel is in the limelight as an alternative fuel because hydrogen is eco-friendly and highly efficient, and the range of use is expanding not only for hydrogen vehicles that use hydrogen as fuel, but also for small devices such as drones.

Such hydrogen is supplied and stored in a liquefied state, and the liquefied hydrogen is stored in a cryogenic state, and cryogenic fluid such as liquefied hydrogen is stored in a storage tank, and it needs to be properly supplied to a predetermined supply target (e.g., a fuel cell or a hydrogen vehicle).

At this time, in order to smoothly supply a fluid such as liquefied hydrogen from the storage tank, the internal pressure in the storage tank must be maintained at an appropriate level, and when the internal pressure is low, the supply of the fluid itself may not be performed properly.

Accordingly, pressure buildup units for controlling the internal pressure of a storage tank storing such a fluid are known.

FIGS. 1A-1B are diagrams for explaining a conventional pressure buildup system.

First, referring to FIG. 1A, a gravity pressure buildup unit (g-PBU) is shown.

In the gravity pressure buildup unit, cryogenic liquid fuel (hereinafter referred to as fluid) is naturally discharged by gravity through a line connected to the lower end of the storage tank, and in order to increase the initial internal pressure, the valve V2 is opened first, and gaseous fuel vaporized while passing through the heat exchanger HX2 is injected through line B connected to the upper end of the storage tank 10 to increase the internal pressure of the storage tank 10.

Then, when the internal pressure of the storage tank 10 reaches the preset pressure, the fuel may be supplied to the supply target 20 through the line A by opening the valve V1. In addition, it is possible to maintain the set pressure in a state where the valve V2 is opened by using a predetermined automatic pressure control means 30.

In the case of this gravity pressure buildup unit, if the height h of a fluid 11 inside the storage tank 10 is small, the flow rate of the fluid discharged by gravity is small, making it virtually impossible to increase the pressure, and in particular, since the stored fluid 11 is discharged under the influence of gravity, there is a problem in that it cannot be used in mobility such as drones or airplanes when the tilt change is severe or the supply target is overturned.

Unlike the gravity pressure buildup unit, a non-gravity pressure buildup unit (ng-PBU) that is relatively unaffected by gravity is shown in FIG. 1B.

In FIG. 1B, a line A connected to the supply target 20 from the storage tank 10 and a line B branched from the line A to pass through the inside of the storage tank 10 and be connected to the line A again may be formed.

In the non-gravity pressure buildup unit, the fluid 11, i.e., the fuel, is supplied to the supply target 20 while the valve V is open, and when the internal pressure of the storage tank 10 drops below a certain level, the internal pressure of the storage tank 10 may be increased by passing the fuel whose temperature has increased while passing through the heat exchanger HX1 back to the fluid 11 in the storage tank 10 through the line B pipe. Pressure control inside the storage tank 10 may be performed by the pressure control means (e.g., 30 and 31).

Unlike the gravity pressure buildup unit, such a non-gravity pressure buildup unit may be operated even when a supply target is overturned, and thus may be a unit relatively suitable for mobility such as the aforementioned aircraft or drone.

However, in this conventional non-gravity pressure buildup unit, since there is no fluid 11 discharged to line A at the lower end of the storage tank 10 when valve V is closed, there is no way to increase the internal pressure of the storage tank 10, making it difficult to use in practice.

As such, in conventional units, in the initial stage of fluid supply for driving the supply target, waiting time becomes longer because it is virtually impossible to supply the fluid to the supply target until the internal pressure of the storage tank reaches the preset set pressure, so there is a great inconvenience in the use of a device that uses liquefied hydrogen as fuel, and there is a problem in that efficiency is lowered due to problems with each unit.

Therefore, a technical idea of, while supplementing the problems of each unit by selectively operating each unit of gravity type and non-gravity type as needed within one system, simplifying the structure thereof to greatly improve efficiency in manufacturing and use is required.

### PRIOR ART DOCUMENT

### Patent Document

Patent Document 1. Korean Patent (Korean Patent No. 10-2021038, “Storage Tank”)

### SUMMARY

An object to be achieved by the present disclosure is to provide a technical idea that allows the conventional gravity and non-gravity pressure buildup units to be selectively implemented as needed in a single pressure buildup system with a simple and efficient structure. A pressure buildup system according to an embodiment of the present disclosure for achieving the above technical object may include a storage tank in which cryogenic fluid is stored, a discharge line communicating with a lower part of the storage tank so that the stored fluid flows, a first line branched from the discharge line and having one end connected to an upper part of the storage tank to perform gravity pressure buildup, a second line branched from the discharge line and having one end connected to a supply target, and a third line having one end branched from a first point of the second line and the other end formed to be connected to the second line at a second point outside the storage tank after a part passes inside the fluid stored in the storage tank to perform non-gravity pressure buildup.

In addition, the pressure buildup system of the cryogenic fluid storage tank may include a controller configured to control a flow of the fluid in each line according to an internal pressure of the storage tank, wherein the controller may be configured to allow the fluid to pass through the first line until the internal pressure of the storage tank reaches a preset set pressure, and when the internal pressure of the storage tank reaches the set pressure, control the fluid to be supplied to the supply target through the second line or the third line.

In addition, the pressure buildup system of the cryogenic fluid storage tank may include a first valve formed in the first line to control the fluid flow to the first line, and a second valve formed in the second line to control the fluid flow to the second line, and the controller may be configured to control an operation of at least one of the first valve or the second valve, wherein the controller may be configured to open the first valve until the internal pressure of the storage tank reaches a preset set pressure so that the fluid passes through the first line, when the internal pressure of the storage tank reaches the set pressure, open the second valve after closing the first valve so that the fluid is supplied to the supply target through the second line, and when the internal pressure of the storage tank decreases below a predetermined level while the second valve is open, allow the fluid to be supplied to the supply target through the third line.

In addition, the pressure buildup system may include a first heat exchanger formed in the first line, a second heat exchanger formed at a location before the third line is branched from the second line, and a third heat exchanger formed at a location before being connected to the supply target in the third line, so that a temperature of the fluid passing through the first heat exchanger, the second heat exchanger, or the third heat exchanger may increase.

A pressure buildup system of a cryogenic fluid storage tank according to another embodiment of the present disclosure for achieving the above technical object may include a storage tank in which cryogenic fluid is stored, a discharge line communicating with a lower part of the storage tank so that the stored fluid flows, a first line having one end connected to the discharge line and the other end connected to a supply target, a second line branched from the first line at a third point to communicate with an inside of the storage tank to perform gravity pressure buildup, and a third line branched from the first line at a fourth point and having one end formed to be connected at a fifth point of the first line outside the storage tank after a part passes inside the fluid stored in the storage tank to perform non-gravity pressure buildup.

In addition, the pressure buildup system of the cryogenic fluid storage tank may include a controller configured to control a flow of the fluid in each line according to an internal pressure of the storage tank, wherein the controller may be configured to allow the fluid to pass through the second line until the internal pressure of the storage tank reaches a preset set pressure, and when the internal pressure of the storage tank reaches the set pressure, close a flow to the second line and control the fluid to be supplied to the supply target through the first line or the third line.

In addition, the pressure buildup system of the cryogenic fluid storage tank may include a first valve formed in the second line to control the fluid flow to the second line, and a second valve formed at a rear end side of the first line to control the fluid flow to the first line, and the controller may be configured to control an operation of at least one of the first valve or the second valve according to the internal pressure of the storage tank, wherein the controller may be configured to open the first valve until the internal pressure of the storage tank reaches a preset set pressure so that the fluid passes through the second line, when the internal pressure of the storage tank reaches the set pressure, open the second valve after closing the first valve so that the fluid is supplied to the supply target through the first line, and when the internal pressure of the storage tank decreases below a predetermined level while the second valve is open, allow the fluid to be supplied to the supply target through the third line.

In addition, the pressure buildup system of the cryogenic fluid storage tank may include a first heat exchanger formed at a location before the second line or the third line is branched from the first line, and a second heat exchanger formed at a location before the third line branched from the first line is reconnected to the first line, so that a temperature of the fluid passing through the first heat exchanger or the second heat exchanger may increase.

A pressure buildup system of a cryogenic fluid storage tank according to another embodiment of the present disclosure for achieving the above technical object may include a storage tank in which cryogenic fluid is stored, a discharge line communicating with a lower part of the storage tank so that the stored fluid flows, a first line having one end connected to the discharge line and the other end connected to a supply target, a second line branched from the first line at a sixth point and having one end formed to be connected at a seventh point of the first line outside the storage tank after a part passes inside the fluid stored in the storage tank to perform non-gravity pressure buildup, and a third line branched from the second line at an eighth point to communicate with an inside of the storage tank to perform gravity pressure buildup.

In addition, the pressure buildup system of the cryogenic fluid storage tank may include a controller configured to control a flow of the fluid in each line according to an internal pressure of the storage tank, wherein the controller may be configured to allow the fluid to pass through the third line until the internal pressure of the storage tank reaches a preset set pressure, and when the internal pressure of the storage tank reaches the set pressure, control the fluid to be supplied to the supply target through the first line or the second line.

In addition, the pressure buildup system of the cryogenic fluid storage tank may include a first valve formed in the third line to control the fluid flow to the third line, and a second valve formed at a rear end side of the first line to control the supply of the fluid to the supply target, wherein the controller may be configured to, while controlling an operation of at least one of the first valve or the second valve according to the internal pressure of the storage tank, open the first valve until the internal pressure of the storage tank reaches a preset set pressure so that the fluid passes through the third line, when the internal pressure of the storage tank reaches the set pressure, open the second valve after closing the first valve so that the fluid is supplied to the supply target through the first line, and when the internal pressure of the storage tank decreases below a predetermined level while the second valve is open, allow the fluid to be supplied to the supply target through the second line.

In addition, the pressure buildup system may include a first heat exchanger formed at a location before the second line is branched from the first line, and a second heat exchanger formed at a location before being connected to the supply target in the second line, so that a temperature of the fluid passing through the first heat exchanger or the second heat exchanger may increase.

According to an embodiment of the present disclosure, by selectively implementing the conventional gravity and non-gravity pressure buildup units as needed with a simple and efficient structure in one pressure buildup system, it may substantially have the effect of increasing the capacity of the pressure buildup system (gravity type+non-gravity type), and since the initial pressure inside the storage tank in which fluid such as liquefied hydrogen is stored may be raised relatively quickly, there is an effect that the waiting time for fuel (e.g., liquefied hydrogen) supply may be remarkably reduced.

### BRIEF DESCRIPTION OF DRAWINGS

In order to more fully understand the drawings cited in the detailed description of the present disclosure, a brief description of each drawing is provided.

FIG. 1A is a diagram for explaining a conventional pressure buildup system.

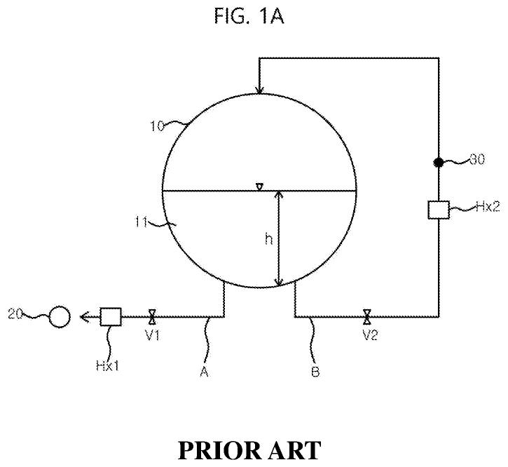

FIG. 1B is another diagram for explaining a conventional pressure buildup system.

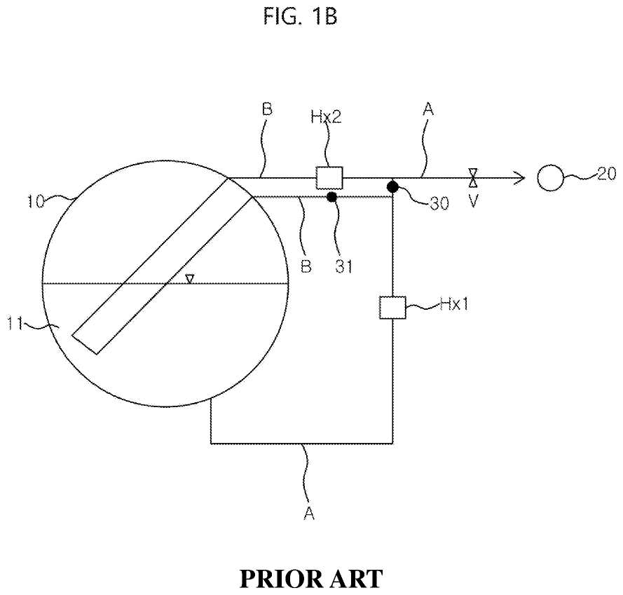

FIG. 2 illustrates a schematic structure of a pressure buildup system of a cryogenic fluid storage tank according to an embodiment of the present disclosure.

FIG. 3 illustrates a schematic structure of a pressure buildup system of a cryogenic fluid storage tank according to another embodiment of the present disclosure.

FIG. 4 illustrates a schematic structure of a pressure buildup system of a cryogenic fluid storage tank according to another embodiment of the present disclosure.

### DETAILED DESCRIPTIONS OF EXEMPLARY EMBODIMENTS

Since the present disclosure may apply various transformations and have various embodiments, specific embodiments will be illustrated in the drawings and described in detail in the detailed description. However, this is not intended to limit the present disclosure to specific embodiments, and it should be understood to include all transformations, equivalents and substitutes included in the spirit and scope of the present disclosure. In describing the present invention, if it is determined that a detailed description of related known technologies may obscure the gist of the present disclosure, the detailed description will be omitted.

Terms such as first and second may be used to describe various components, but the components should not be limited by the terms. The terms are used only for the purpose of distinguishing one component from another.

The terms used in the present application are used only to describe a particular embodiment and are not intended to limit the present disclosure. Singular expressions include plural expressions unless the context clearly means otherwise.

In this specification, terms such as “include” or “have” are intended to designate the presence of features, numbers, steps, operations, components, parts, or combinations thereof described in the specification, and it should be understood that it does not preclude the possibility of the presence or addition of one or more other features, numbers, steps, operations, components, parts, or combinations thereof.

Hereinafter, with reference to the accompanying drawings, the present disclosure will be described in detail centering on embodiments of the present disclosure. Like reference numerals in each figure indicate like members.

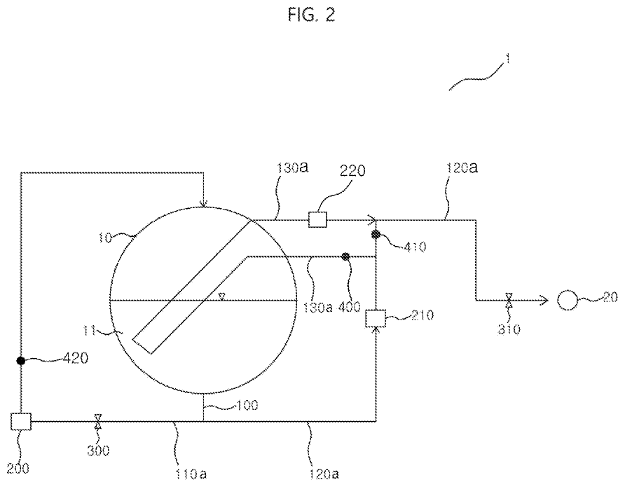

FIG. 2 illustrates a schematic structure of a pressure buildup system of a cryogenic fluid storage tank according to an embodiment of the present disclosure.

Referring to FIG. 2, a pressure buildup system (1, hereinafter referred to as the pressure buildup system) of a cryogenic fluid storage tank according to an embodiment of the present disclosure may include a storage tank 10 in which cryogenic fluid 11 is stored, a discharge line 100 communicating with a lower part of the storage tank 10 so that the stored fluid flows, a first line 110a branched from the discharge line 100 and having one end connected to an upper part of the storage tank 10 to perform gravity pressure buildup, a second line 120a branched from the discharge line 100 and having one end connected to a supply target 20, and a third line 130a having one end branched from a first point of the second line 120a and the other end formed to be connected to the second line 120a at a second point outside the storage tank 10 after a part passes inside of the fluid 11 stored in the storage tank 10 to perform non-gravity pressure buildup. The first point may refer to a location relatively close to the discharge line 100 compared to the second point. In addition, as will be described later, when a heat exchanger (e.g., 210) is provided in the second line 120a, the first point and the second point may be located after, from the discharge line 100, the second line 120a passes through the heat exchanger (e.g., 210).

In addition, the pressure buildup system 1 may include a first valve 300 formed in the first line 110a to control the fluid 11 flow to the first line 110a, and a second valve 310 formed in the second line 120a to control the fluid flow to the second line 120a, and a controller (i.e., 420) configured to control an operation of the first valve 300 according to the internal pressure of the storage tank 10 and a controller (e.g., 400, 410) configured to control an operation of the second valve 310.

The controller (e.g., 400, 410, 420) may refer to a device or system capable of opening or closing the valves and/or respective lines so that the fluid 11 passes through a specific line according to the internal pressure of the storage tank 10.

For example, the controller (e.g., 400, 410) may be formed to have a mechanical configuration capable of automatically operating when the internal pressure of the storage tank reaches a specific pressure, and depending on the implementation example, it may be formed to have an electronic configuration including a predetermined sensor for sensing the internal pressure of the storage tank 10 and operating according to the pressure value sensed by the sensor. In any case, the controller (e.g., 400, 410) may be implemented to control (e.g., opening/closing of valves and/or lines) a line through which the fluid 11 passes according to the internal pressure of the storage tank 10.

The pressure buildup unit by the pressure buildup system 1 according to the technical idea of the present disclosure will be described as follows.

The pressure buildup system 1 may efficiently increase the initial pressure in the storage tank 10 in the same way as the conventional gravity pressure buildup unit described above at the beginning of operation. For example, the pressure buildup system 1 may open the first valve 300 until the internal pressure of the storage tank 10 reaches a preset set pressure (e.g., 11 bar, the set pressure may be set variously as needed by factors such as the type of fluid 11 or the capacity of the storage tank 10) to allow the fluid to circulate through the first line 110a. The control of the first valve 300 may be performed by the controller (e.g., 420). In this case, the second valve 310 may be closed.

And when the internal pressure of the storage tank 10 reaches the set pressure, the controller (e.g., 420) closes the first valve 300 and then the second valve 310 is opened so that the fluid 11 may be supplied to the supply target 20 through the second line 120a.

In the present specification, the supply target 20 may be a predetermined target that needs supply or charging of the fluid stored in the storage tank 10.

In an embodiment, when the cryogenic fluid 11 stored in the storage tank 10 is liquefied hydrogen, the supply target 20 may mean a fuel cell using hydrogen as fuel or a hydrogen vehicle directly using hydrogen as fuel. When the fluid 11 is of a different type than liquefied hydrogen, targets that require charging of the corresponding fluid 11 may be the supply target 20. Hereinafter, in the present specification, a case in which the fluid 11 is liquefied hydrogen and the supply target 20 is a fuel cell or a hydrogen vehicle requiring charging (supply) of hydrogen is described as an example, but the present disclosure is not necessarily limited thereto.

In addition, when the fluid 11 is supplied to the supply target 20 and/or the storage tank or the like, it may mean a case in which the fluid 11 is directly supplied to the supply target in a state of the fluid 11, and as will be described later, it may mean a case of being supplied in a state of being vaporized or a state where the temperature has risen through certain other components (e.g., heat exchanger, etc.).

Meanwhile, while the second valve 310 is open and the fluid 11 is supplied to the supply target 20 through the second line 120a, as the amount of the fluid 11 stored in the storage tank 10 decreases, the internal pressure of the storage tank 10 may decrease to a pressure required for supply to the supply target 20 or less. In this case, the controller (e.g., 400, 410) may allow the fluid 11 to be not directly supplied to the supply target 20 only through the second line 120a, but to be supplied to the supply target 20 after passing through the third line 130a. As shown in the drawing, the third line 130a passes inside the storage tank 10 and may be formed to meet (connect) with the second line 120a again outside the storage tank 10. In addition, the third line 130a is formed to pass through the inside of the fluid 11 stored in the storage tank 10, and by a part of the third line 130a passing through the inside of the storage tank 10, the temperature of the fluid 11 inside the storage tank 10 is raised, and the internal pressure of the storage tank 10 may increase again. In addition, the third line 130a may be connected to the second line 120a again to supply the fluid 11 to the supply target 20. At this time, the first valve 300 may still remain closed.

Then, when the internal pressure of the storage tank 10 reaches the set pressure, the controller (e.g., 400, 410) may be implemented so that the fluid 11 may be directly supplied to the supply target 20 without passing through the third line 130a.

Meanwhile, in general, when a predetermined gas such as liquefied hydrogen is liquefied and stored, the temperature of the liquefied fluid 11 may need to be maintained at a cryogenic temperature. In order to supply the cryogenic fluid 11 to the supply target 20 or to inject it into the storage tank 10 to increase the internal pressure of the storage tank 10 like the first line 110, it is necessary to increase the temperature of the fluid 11. To this end, the pressure buildup system 1 may further include at least one heat exchanger (e.g., 200, 210, 220).

In the embodiment shown in FIG. 2, at least one heat exchanger (e.g., 200, 210, 220) may be provided in the first line 110a, the second line 120a, and the third line 130a, respectively.

Among the at least one heat exchanger, the first heat exchanger 200 is located after the first valve 300 of the first line 110a, and may be formed so that heat exchange is performed when the fluid 11 discharged through the discharge line 100 passes through the first line 110a when the first valve 300 is opened. As such, the fluid 11 passing through the first heat exchanger 200 in the first line 110a is vaporized and injected back into the storage tank 10, thereby increasing the internal pressure of the storage tank 10.

In addition, the second heat exchanger 210 is provided in the second line 120a, and may be formed so that heat exchange with respect to the fluid 11 supplied to the supply target 20 is performed.

The third line 130a may be formed to be branched after the second heat exchanger 210 on the second line 120a, and as described above, pass through the inside of the storage tank 10 and then meet the second line 120a again. In addition, the third heat exchanger 220 may be formed at a location after the third line 130a passes inside the storage tank 10 and before it meets the second line 120a again outside the storage tank 10, and through this, heat exchange may be performed so that the fluid 11 passing through the third line 130a may be smoothly supplied to the supply target 20.

According to the technical idea of the present disclosure, in one pressure buildup system 1, the conventional gravity and non-gravity pressure buildup units may be selectively implemented as needed with a simple and efficient structure. Through this, the present disclosure may substantially have the effect of increasing the capacity of the pressure buildup system 1 (gravity type+non-gravity type), and since the initial internal pressure of the storage tank 10 may be raised relatively quickly, there is an effect that the waiting time for fuel (e.g., liquefied hydrogen) charging may be remarkably reduced.

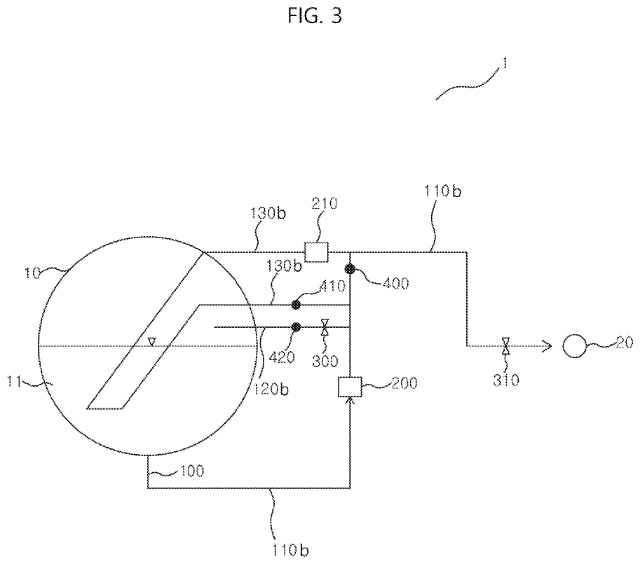

FIG. 3 illustrates a schematic structure of a pressure buildup system of a cryogenic fluid storage tank according to another embodiment of the present disclosure.

Referring to FIG. 3, the pressure buildup system 1 according to another embodiment of the present disclosure may include a storage tank 10 in which cryogenic fluid 11 is stored, a discharge line 100 communicating with a lower part of the storage tank 10 so that the stored fluid flows, and a first line 110b having one end connected to the discharge line 100 and the other end connected to a supply target 20. In addition, the pressure buildup system 1 may include a second line 120b branched from the first line 110b at a third point to communicate with an upper empty space of the storage tank 10 to perform gravity pressure buildup, and a third line 130b branched from the first line 110b at a fourth point and having one end formed to be connected at a fifth point of the first line 110b outside the storage tank 10 after a part passes inside the fluid 11 stored in the storage tank 10 to perform non-gravity pressure buildup.

The third point may refer to a location relatively close to the discharge line 100 compared to the fourth point. In other words, in the embodiment of FIG. 3, the second line 120b branches first from the first line 110b compared to the third line 130b, and the third line 130b may be branched at a location after the second line 120b is branched. A fifth point where the third line 130b is again connected to the first line 110b may refer to a location after the third point and the fourth point. In addition, when a heat exchanger (e.g., 200) is provided in the first line 110b, the third point and the fourth point may be located after the heat exchanger (e.g., 200) from the discharge line 100.

The pressure buildup system 1 according to another embodiment of the present disclosure shown in FIG. 3 is characterized in that, compared to the embodiment described above in FIG. 2, a line capable of increasing the internal pressure of the storage tank 10 in a gravity pressure buildup unit is branched from the first line 110b without being separately branched from the discharge line 100.

This may make it possible to have a relatively simple structure compared to the embodiment described above in FIG. 2. For example, the pressure buildup system 1 according to another embodiment of the present disclosure shown in FIG. 3 eliminates the need for a separate heat exchanger (e.g., the first heat exchanger 200 of FIG. 2) for the gravity pressure buildup unit, so the number of required heat exchangers may be reduced.

As shown in the drawing, in the case of the second line 120b for gravity pressure buildup, it may branch at a location after the first heat exchanger 200 provided in the first line 110b.

In addition, a first valve 300 for controlling the inflow of the fluid 11 into the second line 120b may be formed in the second line 120b, and initially, in a state where the first valve 300 is open and the second valve 310 formed at the rear end side of the first line 110b is closed, the fluid 11 discharged through the discharge line 100 from the storage tank 10 may be vaporized and injected into the storage tank 10 through the first heat exchanger 200 and the second line 120b to increase the internal pressure of the storage tank 10.

Then, when the internal pressure of the storage tank 10 reaches the preset set pressure, while the first valve 300 is closed and the second valve 310 is opened, the fluid 11 may be vaporized and supplied to the supply target 20 through the first line 110b.

When the internal pressure of the storage tank 10 drops while the fluid 11 is supplied to the supply target 20, the controller (e.g., 400, 410) may allow the fluid 11 to pass through the third line 130b.

This is a configuration in which non-gravity pressure buildup may be performed through the third line 130b in the same manner as described above in FIG. 2, and while passing the cryogenic fluid 11 stored in the storage tank 10, the temperature of the lowered fluid 11 may be raised again through the second heat exchanger 210 and supply to the supply target 20 may be performed.

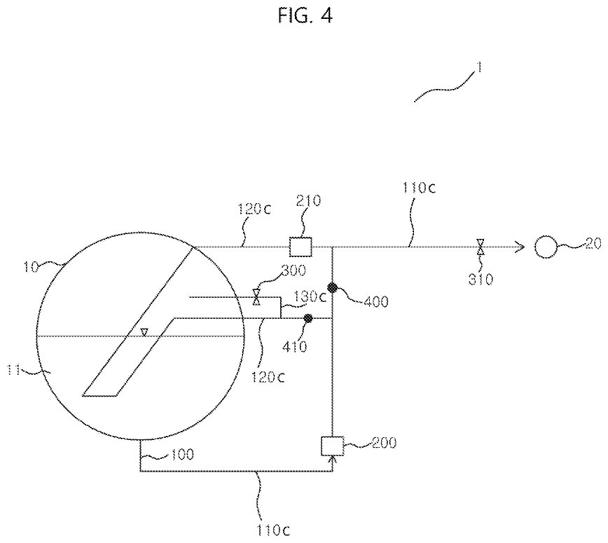

FIG. 4 illustrates a schematic structure of a pressure buildup system of a cryogenic fluid storage tank according to another embodiment of the present disclosure.

Referring to FIG. 4, the pressure buildup system 1 according to another embodiment of the present disclosure may include a storage tank 10 in which cryogenic fluid 11 is stored, a discharge line 100 communicating with a lower part of the storage tank 10 so that the stored fluid flows, and a first line 110c having one end connected to the discharge line 100 and the other end connected to a supply target 20. In addition, the pressure buildup system 1 may include a second line 120 c formed to be branched from the first line 110c at a sixth point so that the non-gravity pressure buildup described above in FIGS. 2 and/or 3 may be achieved, having one end connected again to the seventh point of the first line 110c outside of the storage tank 10, and a third line 120c branched from the second line 120c at a eighth point to communicate with an upper empty space of the storage tank 10 to perform gravity pressure buildup.

The sixth point may refer to a location relatively close to the discharge line 100 compared to the seventh point. In other words, in the embodiment of FIG. 4, the second line 120c may be first branched (sixth point) from the first line 110c, and reconnected to the first line 110c at a location after the sixth point (seventh point) through a non-gravity pressure buildup process. In addition, when a heat exchanger (e.g., 200) is provided in the first line 110c, the sixth point and the seventh point may be located after the heat exchanger (e.g., 200) from the discharge line 100.

In addition, the pressure buildup system 1 according to another embodiment of the present disclosure is the same in that a separate line for gravity pressure buildup is not branched from the discharge line 100 as shown in the pressure buildup system 1 according to another embodiment of the present disclosure described in FIG. 3, but unlike the embodiment in FIG. 3, there is a difference in that the line for gravity pressure buildup (i.e., the third line 120c in FIG. 4) is branched from the line for non-gravity pressure buildup (i.e., the second line 120c in FIG. 4) at the eighth point. The eighth point may be an arbitrary location divided for convenience of description, but preferably, it may mean between the sixth point, i.e., a location after the second line 120c is branched from the first line 110c and a location before the second line 120c enters the storage tank 10. In other words, according to the technical idea of the present disclosure, after the fluid 11 that has passed through the heat exchanger (e.g., 200) in the first line 110c is directed to the second line 120c at the sixth point, and non-gravity pressure buildup may be performed while passing through the second line 120c as needed, or gravity pressure buildup may be performed while passing through the third line 130c.

In any case, according to the technical idea of the present disclosure, as a line for non-gravity pressure buildup is formed inside the storage tank 10, at the beginning of the operation, a line capable of quickly increasing the initial pressure through gravity pressure buildup is formed together, so it may have a feature that may selectively use gravity and non-gravity pressure buildup units with a relatively simple structure.

In the pressure buildup system 1 according to another embodiment of the present disclosure shown in FIG. 4, the heat exchanger may be formed at the same or similar location as the location described above in FIG. 3. For example, in the embodiment of FIG. 4, the first heat exchanger 200 may be formed at the front end of the first line 110c, and the second heat exchanger 210 may be formed at the rear end of the second line 120c, i.e., a line where non-gravity pressure buildup is performed.

The foregoing description of the present disclosure is for illustrative purposes only, and those skilled in the art to which the present disclosure pertains will understand that it can be easily modified into other specific forms without changing the technical idea or essential characteristics of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the detailed description above, and all changes or modifications derived from the meaning and scope of the claims and equivalent concepts thereof should be construed as being included in the scope of the present disclosure.

The present disclosure may be used in a pressure buildup system of a cryogenic fluid storage tank.

1. A pressure buildup system of a cryogenic fluid storage tank, the pressure buildup system comprising:
a storage tank in which cryogenic fluid is stored;
a discharge line communicating with a lower part of the storage tank so that the stored fluid flows;
a first line branched from the discharge line and having one end connected to an upper part of the storage tank to perform gravity pressure buildup;
a second line branched from the discharge line and having one end connected to a supply target; and
a third line having one end branched from a first point of the second line and the other end formed to be connected to the second line at a second point outside the storage tank after a part passes inside the fluid stored in the storage tank to perform non-gravity pressure buildup.

2. The pressure buildup system of claim 1, wherein the pressure buildup system of the cryogenic fluid storage tank comprises a controller configured to control a flow of the fluid in each line according to an internal pressure of the storage tank, and
wherein the controller is configured to allow the fluid to pass through the first line until the internal pressure of the storage tank reaches a preset set pressure, and when the internal pressure of the storage tank reaches the set pressure, control the fluid to be supplied to the supply target through the second line or the third line.

3. The pressure buildup system of claim 2, wherein the pressure buildup system of the cryogenic fluid storage tank comprises:
a first valve formed in the first line to control the fluid flow to the first line; and
a second valve formed in the second line to control the fluid flow to the second line, and
the controller is configured to control an operation of at least one of the first valve or the second valve,
wherein the controller is configured to open the first valve until the internal pressure of the storage tank reaches a preset set pressure so that the fluid passes through the first line, when the internal pressure of the storage tank reaches the set pressure, open the second valve after closing the first valve so that the fluid is supplied to the supply target through the second line, and
when the internal pressure of the storage tank decreases below a predetermined level while the second valve is open, allow the fluid to be supplied to the supply target through the third line.

4. The pressure buildup system of claim 1, wherein the pressure buildup system of the cryogenic fluid storage tank comprises:
a first heat exchanger formed in the first line;
a second heat exchanger formed at a location before the third line is branched from the second line; and
a third heat exchanger formed at a location before being connected to the supply target in the third line,
so that a temperature of the fluid passing through the first heat exchanger, the second heat exchanger, or the third heat exchanger increases.

5. A pressure buildup system of a cryogenic fluid storage tank, the pressure buildup system comprising:
a storage tank in which cryogenic fluid is stored;
a discharge line communicating with a lower part of the storage tank so that the stored fluid flows;
a first line having one end connected to the discharge line and the other end connected to a supply target;
a second line branched from the first line at a third point to communicate with an inside of the storage tank to perform gravity pressure buildup; and
a third line branched from the first line at a fourth point and having one end formed to be connected at a fifth point of the first line outside the storage tank after a part passes inside the fluid stored in the storage tank to perform non-gravity pressure buildup.

6. The pressure buildup system of claim 5, wherein the pressure buildup system of the cryogenic fluid storage tank comprises:
a controller configured to control a flow of the fluid in each line according to an internal pressure of the storage tank, and
wherein the controller is configured to allow the fluid to pass through the second line until the internal pressure of the storage tank reaches a preset set pressure, and when the internal pressure of the storage tank reaches the set pressure, close a flow to the second line and control the fluid to be supplied to the supply target through the first line or the third line.

7. The pressure buildup system of claim 6, wherein the pressure buildup system of the cryogenic fluid storage tank comprises:
a first valve formed in the second line to control the fluid flow to the second line; and
a second valve formed at a rear end side of the first line to control the fluid flow to the first line, and
the controller is configured to control an operation of at least one of the first valve or the second valve according to the internal pressure of the storage tank, and
wherein the controller is configured to open the first valve until the internal pressure of the storage tank reaches a preset set pressure so that the fluid passes through the second line, when the internal pressure of the storage tank reaches the set pressure, open the second valve after closing the first valve so that the fluid is supplied to the supply target through the first line, and
when the internal pressure of the storage tank decreases below a predetermined level while the second valve is open, allow the fluid to be supplied to the supply target through the third line.

8. The pressure buildup system of claim 5, wherein the pressure buildup system of the cryogenic fluid storage tank comprises:
a first heat exchanger formed at a location before the second line or the third line is branched from the first line; and
a second heat exchanger formed at a location before the third line branched from the first line is reconnected to the first line,
so that a temperature of the fluid passing through the first heat exchanger or the second heat exchanger increases.

9. A pressure buildup system of a cryogenic fluid storage tank, the pressure buildup system comprising:
a storage tank in which cryogenic fluid is stored;
a discharge line communicating with a lower part of the storage tank so that the stored fluid flows;
a first line having one end connected to the discharge line and the other end connected to a supply target;
a second line branched from the first line at a sixth point and having one end formed to be connected at a seventh point of the first line outside the storage tank after a part passes inside the fluid stored in the storage tank to perform non-gravity pressure buildup; and
a third line branched from the second line at an eighth point to communicate with an inside of the storage tank to perform gravity pressure buildup.

10. The pressure buildup system of claim 9, wherein the pressure buildup system of the cryogenic fluid storage tank comprises:
a controller configured to control a flow of the fluid in each line according to an internal pressure of the storage tank, and
wherein the controller is configured to allow the fluid to pass through the third line until the internal pressure of the storage tank reaches a preset set pressure, and when the internal pressure of the storage tank reaches the set pressure, control the fluid to be supplied to the supply target through the first line or the second line.

11. The pressure buildup system of claim 10, wherein the pressure buildup system of the cryogenic fluid storage tank comprises:
a first valve formed in the third line to control the fluid flow to the third line; and
a second valve formed at a rear end side of the first line to control the supply of the fluid to the supply target, and
the controller is configured to control an operation of at least one of the first valve or the second valve according to the internal pressure of the storage tank, and
wherein the controller is configured to open the first valve until the internal pressure of the storage tank reaches a preset set pressure so that the fluid passes through the third line, when the internal pressure of the storage tank reaches the set pressure, open the second valve after closing the first valve so that the fluid is supplied to the supply target through the first line, and
when the internal pressure of the storage tank decreases below a predetermined level while the second valve is open, allow the fluid to be supplied to the supply target through the second line.

12. The pressure buildup system of claim 9, wherein the pressure buildup system comprises:
a first heat exchanger formed at a location before the second line is branched from the first line; and
a second heat exchanger formed at a location before being connected to the supply target in the second line,
so that a temperature of the fluid passing through the first heat exchanger or the second heat exchanger increases.
